(19) United States
(12) Patent Application Publication
(10) Pub. No.: US 2019/0323098 A1
(43) Pub. Date: Oct. 24, 2019

(54) DIRECT REDUCTION PROCESS FOR THE PRODUCTION OF DIRECT-REDUCED IRON WITH HIGH PURITY METHANE

(71) Applicant: SABIC Global Technologies B.V., Bergen op Zoom (NL)

(72) Inventors: Nareshkumar Bernard HANDAGAMA, Sugar Land, TX (US); Zheng LIU, Sugar Land, TX (US)

(21) Appl. No.: 16/471,115

(22) PCT Filed: Dec. 14, 2017
(86) PCT No.: PCT/IB2017/057966

§ 371 Date: Jun. 19, 2019

Related U.S. Application Data
(60) Provisional application No. 62/437,835, filed on Dec. 22, 2016.

(51) Int. Cl. C21B 13/00; B01D 53/22; B01D 53/047

(52) U.S. Cl. CPC C21B 13/0073; B01D 53/22; B01D 2256/245; C21B 2100/284; B01D 2257/102; B01D 53/047

(57) ABSTRACT

Systems and processes to produce direct reduced iron with a gaseous reducing stream having less than 10 mol. % nitrogen (N₂) and greater than 80 mol. % methane (CH₄) are described. A process includes separating N₂ from a gaseous stream to produce the reducing stream and contacting the reducing stream with iron ore under conditions sufficient to form direct-reduced iron. The reduction in the N₂ content of the reducing stream improves the overall steel producing capacity by at least 2%.

### CROSS REFERENCE TO RELATED APPLICATIONS

This application claims the benefit of priority of U.S. Provisional Application No. 62/437,835, filed Dec. 22, 2016, which is hereby incorporated by reference in its entirety.

### BACKGROUND OF THE INVENTION

### A. Field of the Invention

The invention generally concerns processes to produce direct reduced iron with a gaseous reducing stream having less than 10 mol. % nitrogen (N2) and greater than 80 mol. % methane (CH4). In particular, the process includes separating nitrogen from a gaseous stream to produce the gaseous reducing stream and contacting the gaseous reducing stream with iron ore under conditions sufficient to form direct-reduced iron.

### B. Description of Related Art

In a steel manufacturing plant, iron (Fe) ore (iron in oxide form and mixed with silicates and other minerals as mined) can be processed to extract the iron and reject/separate the non-metallic material. The iron ore can be a mixture of ferric, non-ferric metals, and other non-metallic compounds. In the iron ore the element ferric is at an oxidized state i.e., as a mixture of ferric and ferrous oxides. Iron and steel are each solid solutions (alloys) of Fe, carbon (C), and silicon (Si) atoms with carbon being the main alloying element. Material having up to 2% C is referred to as “steel.” Material having above 2% C is considered “iron.” “Reduced iron” derives its name from the chemical change that iron ore undergoes when it is heated in a furnace at high temperatures in the presence of hydrocarbon-rich gasses. Direct reduction refers to processes, which reduce iron oxides to metallic iron at temperatures below the melting point of the metallic iron (e.g., 1200° C.). The product of such solid state processes is referred to as direct-reduced iron.

A conventional method to produce direct-reduced iron (DRI) can include direct reduction of iron ore (in the form of lumps, pellets or fines) using a reducing gas produced from hydrocarbons. Conventional reducing gas in a DRI process can be a mixture of hydrogen (H2) and carbon monoxide (CO) produced from the combustion of hydrocarbons (e.g., natural gas, liquid hydrocarbons, coal, or the like). Some DRI processes can use natural gas, as methane (CH4) can act as a reducing agent. Although natural gas can be used in DRI plants as a reducing agent such plants have difficulty in achieving full production capacity.

### SUMMARY OF THE INVENTION

A discovery has been made that provides a solution to the production and inefficiency problems associated with using natural gas as a reducing gas in a DRI process. The solution is premised on the idea to reduce or substantially lower the amount of non-reducing agents (e.g., N2) present in a hydrocarbon stream (e.g., natural gas). The modified or treated hydrocarbon stream can then be used more efficiently as a reducing gas in a DRI process. In particular, removal of the non-reducing agents can provide a gaseous reducing stream that has a higher reducing agent content, allowing more iron ore to be reduced per volume of gas, and thereby resulting in an improved production capacity of the iron steel processes. By way of example, using a reducing gas stream having greater than 80 mol. % methane, preferably at least 87 mol. % can increase the steel production capacity made from DRI by at least 2%, at least 5%, at least 9%, or at least 15%. Notably, the process can be self-sustaining as all the energy requirements for the separation of non-reducing agents can be obtained from energy (e.g., thermal energy/heat) captured from the DRI process.

Embodiments of the present invention describe direct reduction systems and processes for producing direct-reduced iron. The processes can include (a) subjecting a gaseous stream comprising methane (CH4) and nitrogen (N2) to conditions sufficient to separate N2 from the gaseous stream and form a gaseous reducing stream comprising less than 10 mol. % N2, preferably less than 7 mol. %, and greater than 80 mol. % CH4, preferably at least 85 mol. %, and (b) contacting the gaseous reducing stream of step (a) with iron ore under conditions sufficient to form direct-reduced iron. The energy from the conditions of step (b) can be captured and provided to the separation conditions of step (a). The conditions sufficient to form direct-reduced iron can include: (i) heating the gaseous reducing stream; (ii) contacting the heated gaseous reducing stream with iron ore to form direct-reduced iron; and (iii) capturing energy from step (i) and/or step (ii) and providing the captured energy to step (a). Substantially all of the energy required for the separation conditions of step (a) is obtained from the captured energy (e.g., captured heat). The gaseous reducing stream can include 80 to 99 mol. % CH4, 85 to 98 mol. % CH4, or 90 to 95 mol. % CH4 and/or 0 to 10 mol. % N2, 2 to 6 mol. % N2, or 4 to 6 mol. % N2. In some embodiments, the separation conditions can include flowing the gaseous stream through a membrane system to produce gaseous reducing stream and a N2-containing stream. In other embodiments, the separation conditions can include cryogenically distilling the gaseous stream comprising CH4 and N2 to produce the gaseous reducing stream and a N2-containing stream. The N2-containing stream can include N2 and CH4. Heat can be generated from the N2-containing stream by combusting the N2-containing stream, and providing the heat to one or more steel production processes. Conditions sufficient to form direct-reduced iron can include heating the gaseous reducing stream of step (a) in the presence of an oxidant to produce a second gaseous reducing stream comprising unreacted CH4, CO, and H2. The second gaseous reducing stream can then be used in the step (b) contacting step to reduce iron ore to direct-reduced iron. The gaseous stream can be natural gas. In some embodiments, the gaseous stream includes 70 to 88 mol. % CH4, 1 to 5 mol. % ethane, 1 to 5 mol. % propane, 7 to 20 mol. % nitrogen, with the balance being carbon dioxide and oxygen. In some embodiments, iron steel can be produce from the direct-reduced iron made by the process of the invention, and due to the separation of N2 from the gaseous reducing stream, steel production capacity can be increased by at least 2%, at least 5%, at least 9% or at least 15%.

The following includes definitions of various terms and phrases used throughout this specification.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol.%,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The processes and/or systems of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the processes of the present invention are their abilities to increase production capacity of a DRI process by separation of N2 from natural gas prior to use as a reducing gas in the DRI process.

In the context of the present invention, 15 embodiments are now described. Embodiment 1 is a direct reduction process for producing direct-reduced iron. This process includes the steps of (a) subjecting a gaseous stream containing methane (CH4) and nitrogen (N2) to conditions sufficient to separate N2 from the gaseous stream and form a gaseous reducing stream containing less than 10 mol. % N2 and greater than 80 mol. % CH4; and (b) contacting the gaseous reducing stream with iron ore under conditions sufficient to form direct-reduced iron. Embodiment 2 is the direct reduction process of embodiment 1, further containing capturing energy from step (b) and using the energy in step (a). Embodiment 3 is the direct reduction process of any one of embodiments 1 or 2, wherein conditions sufficient to form direct-reduced iron include (i) heating the gaseous reducing stream; (ii) contacting the heated gaseous reducing stream with iron ore to form direct-reduced iron; and (iii) capturing energy from step (i) and/or step (ii) and providing the captured energy to step (a). Embodiment 4 is the direct reduction process of embodiment 3, wherein substantially all of the energy required for the separation conditions of step (a) is obtained from the captured energy. Embodiment 5 is the direct reduction process of any one of embodiments 1 to 4, wherein the gaseous reducing stream contains 0 to 10 mol. % N2, 2 to 6 mol. % N2, or 4 to 6 mol. % N2. Embodiment 6 is the direct reduction process of any one of embodiments 1 to 5, wherein the gaseous reducing stream contains 85 to 99 mol. % CH4, 87 to 98 mol. % CH4, or 90 to 95 mol. % CH4. Embodiment 7 is the direct reduction process of any one of embodiments 1 to 6, further including the step of producing iron steel from the direct-reduced iron. Embodiment 8 the direct reduction process of embodiment 7, wherein separation of N2 in step (a) increases iron steel production capacity by at least 2%, at least 5%, at least 9%, or at least 15%. Embodiment 9 is the direct reduction process of any one of embodiments 1 to 8, wherein the separation conditions include flowing the gaseous stream through a membrane system to produce the gaseous reducing stream and a N2-containing stream. Embodiment 10 is the direct reduction process of any one of embodiments 1 to 9, wherein the separation conditions include cryogenically distilling the gaseous stream containing CH4 and N2 to produce the gaseous reducing stream and a N2-containing stream. Embodiment 11 is the direct reduction process of any one of embodiments 9 to 10, wherein the N2-containing stream contains N2 and CH4. Embodiment 12 is the direct reduction process of embodiment 11, further includes the step of generating heat from the N2-containing stream by combusting the N2-containing stream, and providing the heat to one or more steel production processes. Embodiment 13 is the direct reduction process of any one of embodiments 1 to 12, wherein the gaseous reducing stream of step (a) is heated in the presence of an oxidant and then contacted with the iron ore in step (b). Embodiment 14 is the direct reduction process of any one of embodiments 1 to 13, wherein the gaseous stream is natural gas. Embodiment 15 is the direct reduction process of any one of embodiments 1 to 14, wherein the gaseous stream contains 70 to 88 mol. % CH4, 1 to 5 mol. % ethane, 1 to 5 mol. % propane, 15 to 20 mol% nitrogen, 0.1 to 1 mol. % with the balance being carbon monoxide and oxygen.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a system to perform the process of the present invention to produce direct-reduced iron.

FIG. 2 is a system that includes a membrane separation system to perform the process of the present invention to produce direct-reduced iron.

FIG. 3 is a system that includes a distillation separation system to perform the process of the present invention to produce direct-reduced iron.

While the invention is susceptible to various modifications and alternative forms, specific embodiments thereof are shown by way of example in the drawings. The drawings may not be to scale.

### DETAILED DESCRIPTION OF THE INVENTION

The DRI processes of the present invention solve the problem of methane being the limiting factor in iron steel production capacity when natural gas is used as the reducing agent. The solution is premised on removing non-reducing agents from the natural gas stream to increase the methane concentration to greater than 80 mol. %, thereby increasing the amount of reducing agent per kilogram of ore to be reduced.

These and other non-limiting aspects of the present invention are discussed in further detail in the following sections with reference to the figures.

### A. Direct Reduction of Iron

Direct reduction (“DR”) of iron (e.g. iron oxide or iron ore) can generate metallic iron in solid form by removing oxygen using a reducing gas. The reducing process can be illustrated by the general reaction scheme below where water and carbon dioxide are obtained as reaction byproducts. The reducing agent can be hydrogen gas, methane, carbon monoxide, or a mixture thereof. In some instances, at the process temperatures, methane is converted to H2 and CO.

Fe₂O₃+Reducing Agent→Fe+H₂O+CO₂ (1)

By the foregoing chemical processes, products such as cold direct reduction iron, hot briquetted iron, and hot direct reduction iron can be manufactured.

### B. Systems and Processes to Produce Direct-Reduced Iron

1. Overall Process

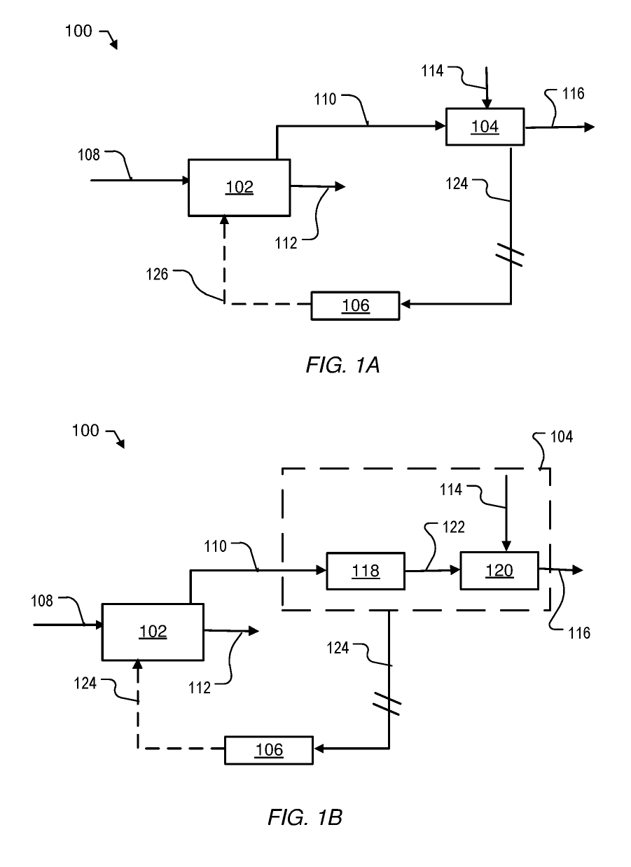

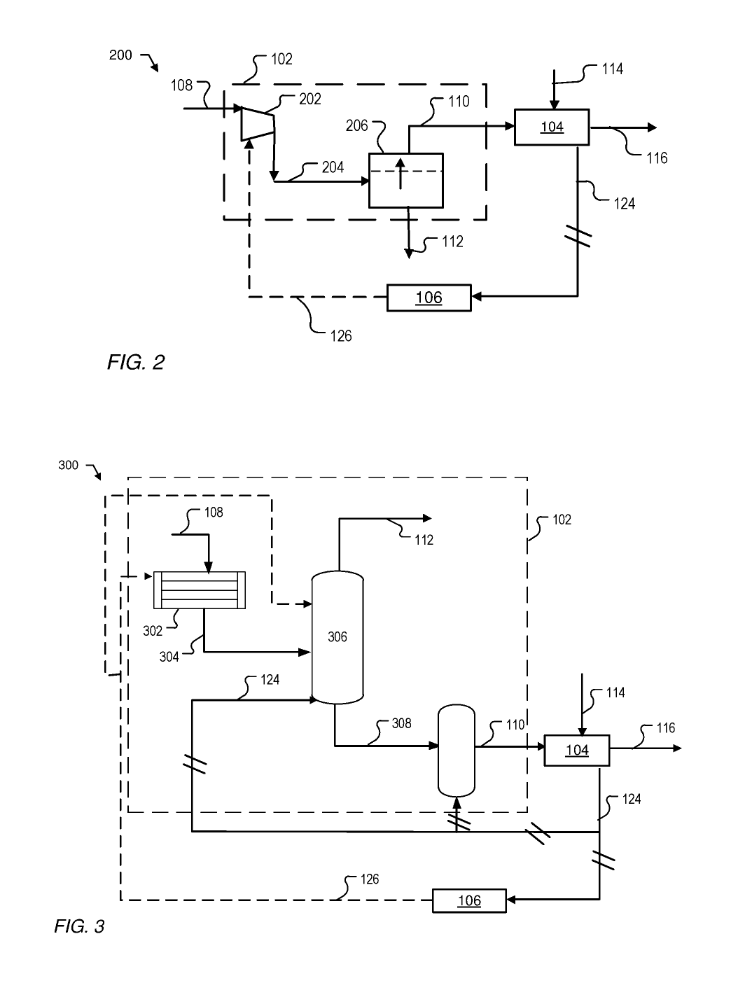

Referring to FIGS. 1A, 1B, 2, and 3, systems to perform the process of the present invention are described. FIG. 1A is a system that includes a separation unit coupled to an iron ore processing unit and an energy capturing unit. FIG. 1B is a system that includes a separation unit coupled to an iron ore processing unit that includes a reforming unit and an energy capturing unit. FIG. 2 is a system that includes a membrane separation system coupled to the iron ore processing unit and an energy capturing unit. FIG. 3 is a distillation system coupled to the DRI unit and an energy capturing unit. Referring to FIG. 1A and FIG. 1B, system 100 includes separation system 102, iron ore processing unit 104, and an energy capturing unit 106. Gaseous hydrocarbon stream 108 can enter separation system 102. In separation system 102, non-reducing agents (e.g., N2) can be separated from gaseous stream 108 to form gaseous reducing stream 110 and N2-containing stream 112. Separation system 102 can include all equipment necessary to separate nitrogen from other gases. Non-limiting examples of separation equipment include membranes, pressure swing adsorption units, distillation units, ionic fluids, and the like. The separation systems can include pumps, compressors, piping, valves, control equipment, heat exchangers, and condensers necessary to perform the separation process. Conditions to effect separation can be determined based on the type of system chosen. FIGS. 2 and 3 provide non-limiting examples of a membrane separation system and a distillation separation system to perform the process of the present invention. N₂-containing stream 112 can include N₂ and optionally hydrocarbons (e.g., methane). N₂-containing stream 112 that includes hydrocarbons can be combusted in the presence of oxygen to generate heat that can be used for other steel making processes.

Gaseous reducing stream 110 and iron ore stream 114 can enter iron ore processing unit 104. Iron ore processing unit 104 can be a direct iron plant. Non-limiting examples of a commercially available iron ore processing units are a MIDREX® (Midrex Technologies, Inc., U.S.A.) unit and HYL plant (Tenova Technologies, Mexico). The iron ore can be pellets, agglomerated iron ore, fines, or combinations thereof. If granular iron oxide feed is used, the oxide feed can be in the form of pellets obtained from a pelletizing plant that pelletizes iron ore fines. In some embodiments, the feed can be in the form of lump iron ore. Granular iron oxide can be greater than about 6 mm to 8 mm in size. If iron oxide fines are used as the feed, the iron oxide feed can be 6 to 12 mm in size. Such fines can be obtained from natural occurring sources, or they can be obtained from a concentrating process to improve their quality.

In iron ore processing unit 104, gaseous reducing stream 110 can contact iron ore stream 114 under conditions sufficient to produce metallic iron stream 116. Conditions for direct reduction of iron can include temperatures of 800° C. to 1100° C., 850° C. to 1050° C., 900° C. to 1000° C., or any range or any value there between. Pressures in iron ore processing unit can range from 0.1 MPa to 7 MPa, 0.15 MPa to 6.5 MPa, 0.2 MPa to 6 MPa, or any value or range there between. Under these conditions the hydrocarbons (e.g., methane) can be reformed to CO and H₂ to provide additional reducing agents in iron ore processing unit 104. In some embodiments, iron ore processing unit 104 includes synthesis gas (syngas) unit 118 and iron reduction unit 120. Referring to FIG. 1A, gaseous reducing stream 108 can enter syngas unit 118 and be subjected to conditions to convert the hydrocarbons (e.g., methane, ethane, propane, and the like) in the gaseous reducing stream to second gaseous reducing stream 122 that is enriched in H₂ and CO as compared to gaseous reducing stream 108. Second gaseous reducing stream 122 can include unreacted hydrocarbons (e.g., methane) from gaseous reducing stream 108. Conversion of the hydrocarbons can be done in the presence of a catalyst or under thermal conditions (e.g. cracking). The conversion conditions can include a temperature of 800° C. to 950° C., 850° C. to 900° C. or any value or range there between and/or a pressure of 0.1 MPa to 1 MPa, 0.15 to 0.5 MPa, or any value or range there between. Second gaseous reducing stream 122 can exit syngas unit 118 and enter iron reduction unit 120 and contact iron ore stream 114 and produce metallic iron stream 116 as previously described.

Energy 124 generated from iron ore processing unit 104 can be transferred to energy capturing unit 106. Energy capturing unit 106 can include any conventional energy capturing unit suitable for capturing energy and transforming the energy (e.g., heat) into electricity 126. By way of example, energy capturing unit 106 can be a Rankine cycle unit or an organic Rankine cycle unit. In energy capturing unit 106, heat can be transferred to a fluid at a constant pressure. The fluid (e.g., water or naphtha) can be vaporized and expanded in a turbine that drives a generator to produce electricity. The spent vapor can be condensed to liquid and recycled back through the cycle. Non-limiting examples of commercial energy capturing units are an ORMAT® Energy Converter (OEC) manufactured by ORMAT (U.S.A) and Turboden ORC manufactured by Turboden S.R. (Italy). Electricity 126 can be provided to separation unit 102 and be used to power equipment used to separate N₂ from gaseous stream 108. By way of example, the equipment can be compressors, membrane units, distillation units, pumps, and the like.

Enriching the gaseous reducing stream in methane (i.e., removing the N₂) by at least 2 mol. % can increase the capacity of the iron steel process by at least 2%. Table 1 and the non-limiting data in the Examples show the percent increase of iron steel capacity by enriching the methane content of the gaseous reducing stream.

TABLE 1

| % Increase in moles of CH₄ | % Increase Of Iron Steel Capacity |
|---|---|
| 2.2 | 2.4 |
| 5.1 | 5.6 |
| 5.2 | 6.0 |
| 5.9 | 6.3 |
| 8.75 | 9 |
| 9.6 | 11.1 |

2. Membrane System

Referring to FIG. 2, a system that includes a membrane separation system coupled to the iron ore processing unit and an energy capturing unit can be used to perform the process of the present invention to produce direct-reduced iron is depicted. System 200 includes separation system 102, iron ore processing unit 104, and energy capturing unit 106. Gaseous hydrocarbon stream 108 enters compressor 202 of separation system 102. Compressor 202 compresses gaseous hydrocarbon stream 108 to increase the pressure of the gaseous hydrocarbon stream to form high pressure gaseous stream 204. By way of example gaseous hydrocarbon stream 108 can be compressed to a pressure of 2 to 5 MPa, 3 to 4 MPa, 3.5 to 4 MPa, or about 3.55 MPa, or any value or range there between. High pressure gaseous stream 204 can enter membrane unit 206. Membrane unit 206 can include any membrane or a series of membranes capable of separating N₂ from hydrocarbons to form gaseous reducing stream 110 and N₂-containing stream 112. By way of example, the membrane can be a polysilioxane membrane such as polydimethylsiloxane. In some embodiments, the membrane is a composite membrane structure. The thickness of the membrane can range between 0.5 and 5.0 μm, 1 to 4 μm, 2 to 3 μm and any ranges or values there between and/or be able to withstand a pressure differential of 3.4 MPa to 11 MPa (about 500 to 1,500 psi), 4 to 10 MPa, 3 to 9 MPa, 4 to 8 MPa, 5 to 7 MPa, or any range or value there between. A composite membrane can include a nonwoven polyester paper, which provides the mechanical strength required for the pressure differential. The nonwoven polyester paper can be coated with a microporous polymer layer selective towards nitrogen (e.g., allows hydrocarbons to pass through the membrane). The surface of the microporous layer can have pores 0.01 to 0.1 μm in diameter, 0.02 to 0.09, 0.03 to 0.08, 0.04 to 0.06 μm. The pores can be bridged when they are coated with the thin selective layer.

In separation system 102, non-reducing agents (e.g., N₂) are separated from gaseous stream 108 to form gaseous reducing stream 110 and N₂-containing stream 112. Gaseous reducing stream 110 can exit membrane unit 204 and enter iron ore processing unit 104. As previously discussed above for FIGS. 1A and 1B, iron ore processing unit 104 can produce direct-reduced iron 116 using gas reducing stream 110 and energy 124. The energy 124 (e.g., heat) can be captured and provided as electricity 126 to compressor 202 and/or membrane unit 204.

3. Distillation Separation System

Referring to FIG. 3, a system that includes a cryogenic separation system coupled to the iron ore processing unit and an energy capturing unit can be used to perform the process of the present invention to produce direct-reduced iron is depicted. System 300 includes separation system 102, iron ore processing unit 104, and energy capturing unit 106. Gaseous hydrocarbon stream 108 enters condenser 302 of separation system 102. Condenser 302 reduces the temperature of gaseous hydrocarbon stream 108 such that the stream liquefies and forms liquid hydrocarbon stream 304 (e.g., liquid natural gas). By way of example, gaseous hydrocarbon stream 108 can be cooled to a temperature of −180 to −150° C., −175 to −165° C., or any value or range there between at a pressure of 0.1 to 0.25 MPa. In one preferred aspect, stream 108 can be cooled at about −176° C. at 0.22 MPa. Liquid hydrocarbon stream 304 can enter distillation unit 306. Distillation unit 306 can be any distillation unit capable of separating N₂ from hydrocarbons to form liquid reducing stream 308 and N₂-containing stream 112. By way of example, the distillation unit can be a single or multi-stage (e.g., 1, 2, 3, or more stage) distillation unit. Cryogenic distillation equipment can be obtained from various vendors, for example, Linde Group (U.S.A.) or built on site. Liquid reducing stream 308 can exit distillation unit 306 and enter flash unit 310. In flash unit 310, liquid reducing stream 308 can be vaporized to form gaseous reducing stream 110. By way of example, liquid reducing stream 308 can be heated to 80 to 100° C., or 85 to 95° C. at 0.1 to 1 MPa, 0.5 to 0.8 MPa, or any range or value there between, or about 90° C. at about 0.79 MPa to produce gaseous reducing stream 110. Gaseous reducing stream 110 can exit flash unit 310, and enter iron ore processing unit 104. As previously discussed above for FIGS. 1A and 1B, iron ore processing unit 104 can produce direct-reduced iron 116 using gas reducing stream 110 and energy 124. The energy 124 can be captured and provided as electricity 126 to compressor 202 and/or membrane unit 204.

### C. Gaseous Hydrocarbon Streams and Gaseous Reducing Streams

Gaseous hydrocarbon stream 108 can include C₁-C₄ hydrocarbons, N₂, and optionally, oxygen (O₂), carbon monoxide, and carbon dioxide. Gaseous hydrocarbon stream 108 can be a natural gas stream that has not been treated to remove nitrogen. Gaseous hydrocarbon stream 108 can include 80 mol. % to up to 90 mol. % CH₄, or 80 mol. %, 81 mol. %, 82 mol. %, 83 mol. %, 84 mol. %, 85 mol. %, 86 mol. %, 87 mol. %, 88 mol. %, 89 mol. %, or 90 mol. %, of CH₄, or any value or range there between. Gaseous hydrocarbon stream can include 7 to 15 mol. %, N2, or 7 mol. %, 8 mol. %, 9 mol. %, 10 mol. %, 11 mol. %, 12 mol. %, 13 mol. %, 14 mol. %, 15 mol. %, of N₂. Other components in gaseous hydrocarbon stream 108 can be present in amounts of 0.05 mol. % or less. In some embodiments, gaseous hydrocarbon stream 108 can include 80 mol. % up to 90 mol. % CH₄, 7 to 15 mol. % N₂, 0 to 3 mol. % ethane, 0 to 1 mol. % propane, 0 to 0.1 mol. % carbon dioxide, and 0 to 0.1 mol. % O₂. By way of example, gaseous hydrocarbon stream 108 can include 80 mol. % CH₄, 15 mol. % N₂, 3 mol. % ethane, 1 mol. % propane, 0.6 mol. % carbon dioxide, and 0.6 mol. % O₂. In another example, gaseous hydrocarbon stream 108 can include about 85 mol. % CH₄, 10 mol. % N₂, 2.8 mol. % ethane, 1 mol. % propane, 0.6 mol. % carbon dioxide, and 0.6 mol. % O₂. In yet another example, gaseous hydrocarbon stream 108 can include about 88 mol. % CH₄, 7 mol. % N₂, 2.8 mol. % ethane, 1 mol. % propane, 0.6 mol. % carbon dioxide, and 0.6 mol. % O₂.

Gaseous reducing stream 110 can include can include 87 mol. % to 100 mol. % CH₄, or 87 mol. %, 88 mol. %, 89 mol. %, 90 mol. %, 91 mol. %, 92 mol. %, 93 mol. %, 94 mol. %, 95 mol. %, 96 mol. %, 97 mol. %, 98 mol. %, 99 mol. % or 90 mol. %, of CH₄, or any value or range there between. The amount of CH₄ in gaseous reducing stream 110 is greater than the amount of methane in the feed gaseous hydrocarbon stream. Gaseous reducing stream can include less than 7 mol. %, N₂, or less than 6 mol. %, 5 mol. %, 4 mol. %, 3 mol. %, 2 mol. %, 1 mol. %, 0.5 mol. %, or 0 mol. % of N2. Other components in gaseous hydrocarbon stream 108 can be present in amounts of 0.05 mol. % or less. In some embodiments, gaseous reducing stream 110 can include 87 mol. % to 100 mol. % CH₄, less than 6 mol. % N₂, 0 to 3 mol. % ethane, 0 to 1 mol. % propane, 0 to 0.1 mol. % carbon dioxide, and 0 to 0.1 mol. % O₂. By way of example, gaseous reducing stream 110 can include about 87 mol. % CH₄, 6 mol. % N₂ and less than 7 mol. % other components. In another example, gaseous reducing stream can include about 90 mol. % CH₄, 4 mol. % N₂, and less than 7 mol. % other components. In another example, gaseous reducing stream 110 can include about 90 mol. % CH₄, 2 mol. % N₂, and less than 8 mol. % other components. In yet another example, gaseous reducing stream 110 can include about 88.5 mol. % CH₄, 6 mol. % N₂, and less than 3.5 mol. % other components. In yet another example, gaseous reducing stream 110 can include about 89.7 mol. % CH₄, 5 mol. % N₂, and less than 5.3 mol. % other components. In yet another example, gaseous reducing stream 110 can include about 92.8 mol. % CH₄, 2 mol. % N₂, and less than 5.2 mol. % other components.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

Examples 1-6 were simulated using Aspen Plus® V8.2 (AspenTech, U.S.A.) using the Peng-Robinson (PENG-ROB) based method. Key mass and energy flow data are given in the examples.

### Example 1

### Process to Produce DRI with Methane Enriched Reducing Stream-Membrane Separation of 15 mol. % N₂

Un-treated natural gas (90° C., 7.9 bar, 300 kg/hr) with the mole fraction of each component given in Table 2 was fed into a membrane separation system. The untreated natural gas was first sent to a compressor where the pressure of the feed gas was increased to 35.5 bar. The high pressure gas was then sent to a methane permeable membrane to separate N₂ rich gas (tail gas) from the untreated natural gas to obtain methane enriched reducing gas (237 kg/hr), which contained only 6 mol. % of N₂ and 87 mol. % of methane. The reducing gas (237 kg/hr, 1750 cuft/hr) can be used to support 76.3 KTA iron steel production, while the same volume of un-treated natural gas can only support 70 KTA iron steel production. In other words, removing N₂ from the natural gas can improve 9% capacity of the iron steel process. Note that the electricity required by running the compressor is about 26.7 kw, which is 8.6% of the total electricity that can be obtained from the waste heat of Midrex through the Organic Rankine Cycle (310.84 kw). Finally, the separated N₂ stream contains >60 mol. % N₂ and small amount of CH₄ (<15 mol. %), which can be burned to recycle the heat in other steel production processes.

TABLE 2

| Component | CH₄ | C₂H₆ | C₃H₈ | N₂ | CO₂ | O₂ |
|---|---|---|---|---|---|---|
| Mole Fraction | 0.8 | 0.028 | 0.01 | 0.15 | 0.006 | 0.006 |

### Example 2

### Process to Produce DRI with Methane Enriched Reducing Stream-Membrane Separation of 10 mol. % N₂

Un-treated natural gas (90° C., 7.9 bar, 274 kg/hr) with the mole fraction of each component given in Table 3 was fed into a membrane separation system. The untreated natural gas was first sent to a compressor where the pressure of the feed gas was increased to 35.5 bar. The high pressure gas was then sent to a methane permeable membrane to separate N₂ rich gas (tail gas) from the untreated natural gas to obtain methane enriched reducing gas (218 kg/hr), which contained only 4 mol. % of N₂ and 90 mol. % of methane. The reducing gas (218 kg/hr, 1650 cuft/hr) can be used to support 74.4 KTA iron steel production, while the same volume of un-treated natural gas can only support 70 KTA iron steel production. In other words, removing N₂ from the natural gas can improve 9% capacity of the iron steel process. Note that the electricity required by running the compressor is about 25 kw, which is 8% of the total electricity that can be obtained from the waste heat of Midrex through the Organic Rankine Cycle (310.84 kw). Finally, the separated N₂ stream contains >60 mol. % N₂ and small amount of CH₄ (<15 mol. %), which can be burned to recycle the heat in other steel production processes.

TABLE 3

| Component | CH₄ | C₂H₆ | C₃H₈ | N₂ | CO₂ | O₂ |
|---|---|---|---|---|---|---|
| Mole Fraction | 0.85 | 0.028 | 0.01 | 0.1 | 0.006 | 0.006 |

### Example 3

### Process to Produce DRI with Methane Enriched Reducing Stream-Membrane Separation of 7 mol. % N₂

Un-treated natural gas (90° C., 7.9 bar, 279 kg/hr) with the mole fraction of each component given in Table 4 was fed into a membrane separation system. The untreated natural gas was first sent to a compressor where the pressure of the feed gas was increased to 35.5 bar. The high pressure gas was then sent to a methane permeable membrane to separate N₂ rich gas (tail gas) from the untreated natural gas to obtain methane enriched reducing gas (212 kg/hr), which contained only 2 mol. % of N₂ and 90 mol. % of methane. The reducing gas (212 kg/hr, 1588 cuft/hr) can be used to support 71.7 KTA iron steel production, while the same volume of un-treated natural gas can only support 70 KTA iron steel production. In other words, removing N₂ from the natural gas can improve 2.4% capacity of the iron steel process. Note that the electricity required by running the compressor is about 27.5 kw, which is 8.8% of the total electricity that can be obtained from the waste heat of Midrex through the Organic Rankine Cycle (310.84 kw). Finally, the separated N₂ stream contains >60 mol. % N₂ and small amount of CH₄ (<15 mol. %), which can be burned to recycle the heat in other steel production processes.

TABLE 4

| Component | CH₄ | C₂H₆ | C₃H₈ | N₂ | CO₂ | O₂ |
|---|---|---|---|---|---|---|
| Mole Fraction | 0.88 | 0.028 | 0.01 | 0.07 | 0.006 | 0.006 |

### Example 4

### Process to Produce DRI with Methane Enriched Reducing Stream-Cryogenic Separation of 15 mol. % N₂

Un-treated natural gas (90° C., 7.9 bar, 279 kg/hr) with the mole fraction of each component given in Table 2 was first condensed to liquid natural gas at −173° C., 2.2 bar (0.22 MPa). The liquid natural gas was sent to a cryogenic 3 stage distillation unit where methane enriched liquid natural gas was obtained that contained 6 mol. % N₂ and 88.5 mol. % methane. The methane enriched liquid natural gas (233.5 kg/hr, 1750cuft/hr) was flashed into the gaseous reducing stream of the present invention at 90° C. at 7.9 bar (about 0.79 MPa) and then sent to a MIDREX® process. The reducing gas can be used to support 77.7 KTA iron steel production, while the same volume of un-treated natural gas can only support 70 KTA iron steel production. In other words, removing N₂ from the natural gas can improve 11.1% capacity of the iron steel process. The total energy required by the condenser, distillation and the flash vaporization is about 1.168 MMBTU/hr, which is about 33% of the total waste heat available from the Midrex process (3.54 MMBTU/hr). Finally, the separated N₂ stream contains >90 mol. % N₂ and small amount of CH₄ (<8 mol. %), which can be burned to recycle the heat in other steel production processes.

### Example 5

### Process to Produce DRI with Methane Enriched Reducing Stream-Cryogenic Separation of 10 mol. % N₂

Un-treated natural gas (90° C., 7.9 bar, 237 kg/hr) with the mole fraction of each component given in Table 3 was first condensed to liquid natural gas at −173° C., 2.2 bar (0.22 MPa). The liquid natural gas was sent to a cryogenic 3 stage distillation unit where methane enriched liquid natural gas was obtained that contained 5 mol. % N₂ and 89.7 mol. % methane. The methane enriched liquid natural gas (271.6 kg/hr, 1650cuft/hr) was flashed into the gaseous reducing stream of the present invention at 90° C. at 7.9 bar (about 0.79 MPa) and then sent to a MIDREX® process. The reducing gas can be used to support 74.2 KTA iron steel production, while the same volume of un-treated natural gas can only support 70 KTA iron steel production. In other words, removing N2 from the natural gas can improve 6% capacity of the iron steel process. The total energy required by the condenser, distillation and the flash vaporization is about 1.053 MMBTU/hr, which is about 30% of the total waste heat available from the Midrex process (3.54 MMBTU/hr). Finally, the separated N₂ stream contains >90 mol. % N₂ and small amount of CH₄ (<8 mol. %), which can be burned to recycle the heat in other steel production processes.

### Example 6

### Process to Produce DRI with Methane Enriched Reducing Stream-Cryogenic Separation of 10 mol. % N₂

Un-treated natural gas (90° C., 7.9 bar, 237 kg/hr) with the mole fraction of each component given in Table 3 was first condensed to liquid natural gas at −173° C., 2.2 bar (0.22 MPa). The liquid natural gas was sent to a cryogenic 3 stage distillation unit where methane enriched liquid natural gas was obtained that contained 2 mol. % N₂ and 92.8 mol. % methane. The methane enriched liquid natural gas (205.5 kg/hr, 1590cuft/hr) was flashed into the gaseous reducing stream of the present invention at 90° C. at 7.9 bar (about 0.79 MPa) and then sent to a MIDREX® process. The reducing gas can be used to support 74 KTA iron steel production, while the same volume of un-treated natural gas can only support 70 KTA iron steel production. In other words, removing N₂ from the natural gas can improve 5.6% capacity of the iron steel process. The total energy required by the condenser, distillation and the flash vaporization is about 1.03 MMBTU/hr, which is about 29% of the total waste heat available from the Midrex process (3.54 MMBTU/hr). Finally, the separated N₂ stream contains >90 mol. % N₂ and small amount of CH₄ (<8 mol. %), which can be burned to recycle the heat in other steel production processes.

1. A direct reduction process for producing direct-reduced iron, the process comprising:
(a) subjecting a gaseous stream comprising methane (CH₄) and nitrogen (N₂) to conditions sufficient to separate N₂ from the gaseous stream and form a gaseous reducing stream comprising less than 10 mol. % N₂ and greater than 80 mol. % CH₄; and
(b) contacting the gaseous reducing stream with iron ore under conditions sufficient to form direct-reduced iron.

2. The direct reduction process of claim 1, further comprising capturing energy from step (b) and using the energy in step (a).

3. The direct reduction process of claim 1, wherein conditions sufficient to form direct-reduced iron comprise:
(i) heating the gaseous reducing stream;
(ii) contacting the heated gaseous reducing stream with iron ore to form direct-reduced iron; and
(iii) capturing energy from step (i) and/or step (ii) and providing the captured energy to step (a).

4. The direct reduction process of claim 3, wherein substantially all of the energy required for the separation conditions of step (a) is obtained from the captured energy.

5. The direct reduction process of claim 1, wherein the gaseous reducing stream comprises 0 to 10 mol. % N₂, 2 to 6 mol. % N₂, or 4 to 6 mol. % Na.

6. The direct reduction process of claim 1, wherein the gaseous reducing stream comprises 85 to 99 mol. % CH4, 87 to 98 mol. % CH₄, or 90 to 95 mol. % CH₄.

7. The direct reduction process of claim 1, further comprising producing iron steel from the direct-reduced iron.

8. The direct reduction process of claim 7, wherein separation of N₂ in step (a) increases iron steel production capacity by at least 2%, at least 5%, at least 9%, or at least 15%.

9. The direct reduction process of claim 1, wherein the separation conditions comprise flowing the gaseous stream through a membrane system to produce the gaseous reducing stream and a N₂-containing stream.

10. The direct reduction process of any claim 1, wherein the separation conditions comprise cryogenically distilling the gaseous stream comprising CH₄ and N₂ to produce the gaseous reducing stream and a N₂-containing stream.

11. The direct reduction process of claim 9, wherein the N₂-containing stream comprises N₂ and CH₄.

12. The direct reduction process of claim 11, further comprising generating heat from the N₂-containing stream by combusting the N₂-containing stream, and providing the heat to one or more steel production processes.

13. The direct reduction process of claim 1, wherein the gaseous reducing stream of step (a) is heated in the presence of an oxidant and then contacted with the iron ore in step (b).

14. The direct reduction process of claim 1, wherein the gaseous stream is natural gas.

15. The direct reduction process of claim 1, wherein the gaseous stream comprises 70 to 88 mol. % CH₄, 1 to 5 mol. % ethane, 1 to 5 mol. % propane, 15 to 20 mol % nitrogen, 0.1 to 1 mol. % with the balance being carbon monoxide and oxygen.

16. The direct reduction process of claim 10, wherein the N₂-containing stream comprises N₂ and CH₄.

17. The direct reduction process of claim 3, further comprising producing iron steel from the direct-reduced iron.

18. The direct reduction process of claim 4, further comprising producing iron steel from the direct-reduced iron.

19. The direct reduction process of claim 5, further comprising producing iron steel from the direct-reduced iron.

20. The direct reduction process of claim 6, further comprising producing iron steel from the direct-reduced iron.
